(19) United States
(12) Patent Application Publication
(10) Pub. No.: US 2007/0011894 A1
(43) Pub. Date: Jan. 18, 2007

(54) Laser alignment device

(76) Inventor: Ming Chen, Nanjing (CN)

Correspondence Address: WALLENSTEIN & WAGNER, LTD., 311 SOUTH WACKER DRIVE, 53RD FLOOR, CHICAGO, IL, 60606, US

(21) Appl. No.: 11/488,880

(22) Filed: Jul. 18, 2006

(30) Foreign Application Priority Data
Jul. 18, 2005 (CN) 200520073680.6

(51) Int. Cl. G01C 15/00

(52) U.S. Cl. 33/286

(57) ABSTRACT

A laser alignment device is disclosed according to the present invention, which may emit a laser beam and form one or more reference lines on an object surface. The laser alignment device, comprising a body in which a laser emitter is provided, the body is connected with a base that includes a fixing means. The laser alignment device is sucked onto the surface of the object by a suction cup. The suction cup is connected to a cylinder further comprising a piston which may slide therein due to a spring means so that the suction force of the suction cup can be adjusted. This laser alignment device does not cause any damage when fixed onto a wall surface. The fixing means has a strong suction force and may fix the laser alignment device onto the wall surface for a long time, and thus the trouble due to unsteady position or disengagement in operation is reduced.

### CROSS-REFERENCE TO RELATED APPLICATIONS

This application claims priority to Chinese Application No. 200520073680.6, filed on Jul. 18, 2005, the entire disclosure of which is incorporated herein by reference. Priority to this application is claimed under 35 U.S.C. 119, 120 and/or 365.

### FEDERALLY SPONSORED RESEARCH OR DEVELOPMENT

None.

### TECHNICAL FIELD

This invention relates to a laser device in which an emitted laser beam may form one or more reference lines on the surface of an object, and more particularly, to a laser alignment device with a vacuum base in which a suction cup may be used to fix the laser device onto the wall surface at any angle.

### BACKGROUND OF THE INVENTION

The laser alignment device generally includes a laser-emitting means composed of a laser diode and a lens, which is provided in a housing, and a set of batteries for powering the laser diode. Radiations emitted by the laser diode may be converted into a planar light beam through a lens refraction forming a straight line on the wall surface to be irradiated. Such a line is often used in building construction, upholstery, or decoration. Since such alignments need to be done on wall surfaces, sometimes it is required to fix the laser alignment device onto the wall surface with the operator's hands being free to be able to do other work.

There are several conventional methods to fix the laser alignment device onto the wall in the prior art. U.S. Pat. No. 6,735,879 discloses such a positioning method wherein the bottom of the laser alignment device is provided with an nail or a pin to be drilled into the wall for positioning. U.S. Publication No. 2004/0258126 A1 discloses such a method of sticking the laser alignment device to the wall by double sided adhesive strips. U.S. Patent Publication No. 2005/0022399 A1 discloses a positioning system wherein a suction cup is used to fix the laser alignment device onto the wall, however, the suction force is enhance using a cam pulling rod.

In the various positioning methods mentioned above, using a nail or a pin will obviously destroy the wall surface and using adhesive strips will dirty the wall surface. The positioning system disclosed by U.S. Publication No. 2005/0022399 A1 enhances the suction force by rotating the cam pulling rod, however, such a method does can not solve the problem of air seeping into the suction cup and decreasing the suction force causing the device to fall off the wall surface.

The present invention is provided to solve these and other problems.

### SUMMARY OF THE INVENTION

The object of the present invention is to provide a laser alignment device, the fixing method of which overcomes shortcomings in the prior art, in which the device will be durably sucked onto the wall surface.

To achieve the above-mentioned object, the laser alignment device disclosed in the present invention comprises a body in which a laser emitter is provided. The body is connected with a base that includes a fixing means. The fixing means comprises a suction cup for sucking the body onto a wall surface causing a first cavity to be formed between the suction cup and the wall surface. The fixing means further comprises a cylinder communicated with the suction cup. A piston is provided in the cylinder and is fit closely with the inner wall of the cylinder for dividing the cylinder into a second cavity and a third cavity. The second cavity is communicated with the first cavity. The fixing means further comprises a spring means to move the piston toward the third cavity.

There are multiple advantages by using the above fixing means for the laser alignment device. Firstly, the fixing means using the suction cup will not damage the wall surface. Secondly, while under action of the spring, the piston can move in the cylinder to automatically and efficiently maintain the air pressure in the suction cup within a more constant range so that the suction force can be kept balance for a longer time period, thereby the laser alignment device can be fixed on the wall surface for a long time period, and trouble due to unsteady locating or disengagement is diminished.

The other object of the present invention is to provide a laser alignment device in which the fixing base is disengageable from the body.

To achieve the above object, the body includes a magnet and the base includes a magnet-attractive mass.

With the combination of the body and the base of the laser alignment device having magnetic attraction, the body can be easily disassembled from the base and be displaced to various types of bases to meet requirements of different working surfaces.

Other features and advantages of the invention will be apparent from the following specification taken in conjunction with the following drawings.

### BRIEF DESCRIPTION OF THE DRAWINGS

The various embodiments according to the present invention will be further described in detail combined with the figures hereinafter.

FIG. 1 is a perspective view of the laser alignment device according to the present invention.

FIG. 2 is a perspective view of the fixing means on the base as shown in FIG. 1.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

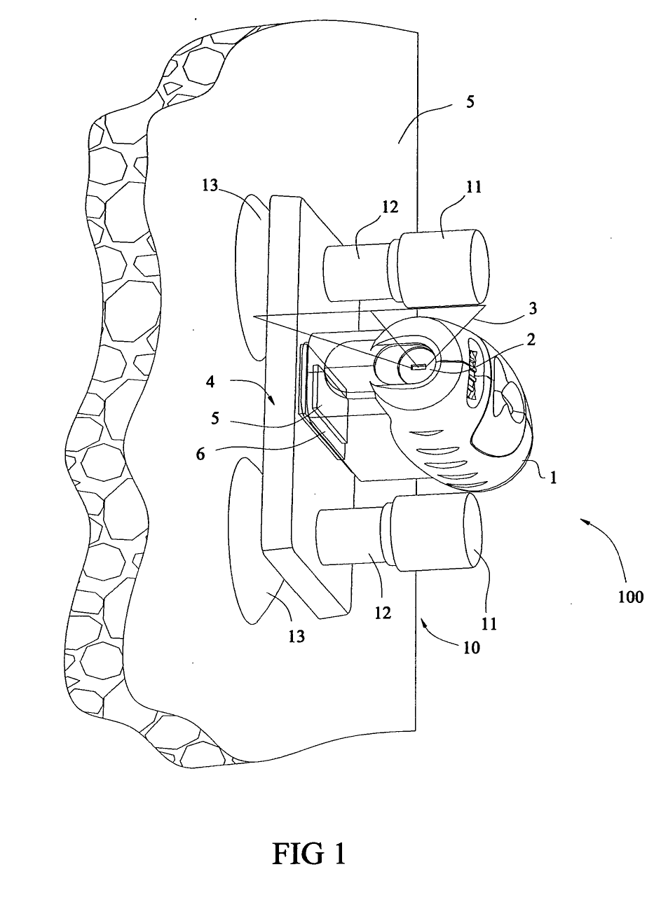

As shown in FIG. 1, a laser alignment device 100 comprises a body 1 and a base 4, a laser emitter 2 is provided in the body 1 and may emit a fan-shaped beam 3. The body I is provided with a bottom magnet 5, and the base 4 is provided with a magnet-attractive mass 6 which may be made of material attractive with magnet such as magnet or iron and the like. The body 1 is coupled with the base 4 by the attraction of the bottom magnet 5 and the magnet-attractive mass 6. A fixing means 10 is provided in each of two ends of the base 4. The body 1 and the base 4 are fixed together on the wall surface 5 by means of the fixing means 10.

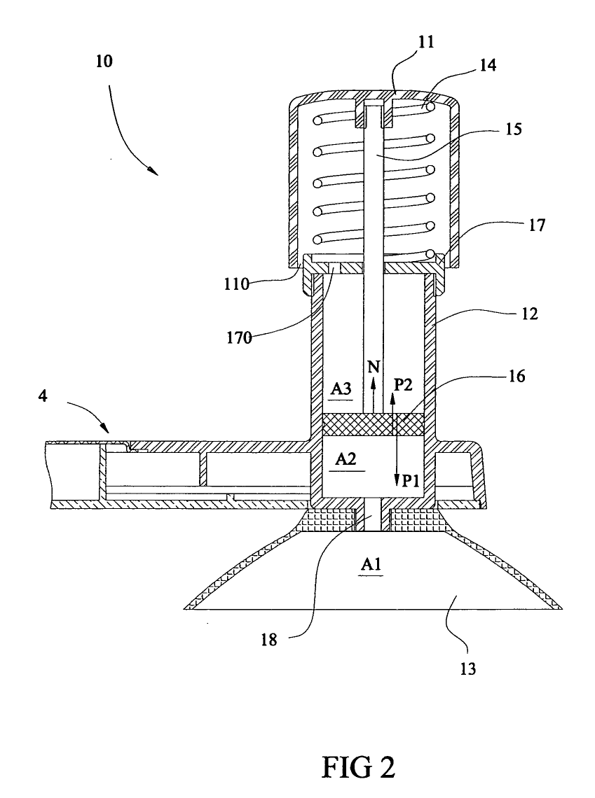

Referring to FIG. 2, the fixing means 10 includes a suction cup 13 which is preferably made of materials such as elastomer, silicone rubber or plastic and the like, and creates a first cavity A1 by being sucked onto the wall surface 5. The top of suction cup 13 is connected to a cylinder 12, the portion connecting the bottom of cylinder 12 with the suction cup 13 has a through hole 18 connecting the first cavity A1 with the inner cavity of cylinder 12. The cylinder 12 is preferably fixed perpendicular to the base 4.

A piston 16 is located in the cylinder 12, which fits closely with the inner wall of cylinder 12 and divides the cylinder 12 into a second cavity A2 and a third cavity A3. The cylinder 12 has a cavity cap 17 at the end away from the suction cup 13, and a hole 170 is provided on the cavity cap 17. The fixing means 10 further comprises a push rod 15 connecting fixedly to the piston 16 at one end for pushing or pulling the piston 16. The other end of the push rod 15 penetrates through the cavity cap 17 to be fixed onto a push-rod cap 11. As shown in FIG. 2, the push-rod cap 11 preferably covers the cavity cap 17 with a proper gap 110 provided in between. As a result, the third cavity A3 is left open. A spring 14 is provided between the cavity cap 17 and the push-rod cap 11.

When fixing the laser alignment device 100 onto the wall surface 5, first, push against the push-rod cap 11 causing the piston 16 to press to the bottom of the cylinder 12, so the spring 14 is compressed with the falling movement of the push-rod cap 11. Then press the suction cup 13 onto the wall surface 5 to exhaust the air out of the first cavity A1. Once the suction cup 13 is sucked onto the wall surface 5, the laser alignment device 100 is fixed. At this time, the first cavity A1 and the second cavity A2 have a very low air density, thus the ratio of the inner to outer air pressure of the suction cup 13 is very high allowing it to be sucked onto the wall surface 5 tightly. The piston 16 can be kept balance under combined action of the air pressure P1, pulling force N produced by the push rod 15 with respect to the piston 16 due to the spring 14, and the air pressure P2 within the first and second cavities A1 and A2, as shown in FIG. 2.

After the laser alignment device 100 is fixed onto the wall surface 5, air will seep into the suction cup 13 so that the air pressure P2 within the first and second cavities A1 and A2 become higher. To keep balance of the piston 16, the piston 16 will move toward the third cavity A3 by the action of the spring 14 causing the total space between the second cavity A2 and the first cavity A1 to become larger and the air density to be reduced causing the piston 16 to reach a balance. The fixing means 10 may automatically adjust the air density within the suction cup 13 and maintain it within a stable density range allowing the suction cup 13 to keep a stable suction force permitting the laser alignment device 100 to not fall off the wall surface.

The preferred embodiment of the present invention is illustrated in the above descriptions and drawings. But the present invention is not limited to this embodiment. For example, the magnet-attractive system of the body 1 and the base 4 may be such a system in which a magnet is mounted on the base 4 and an object attractive with the magnet is mounted on the body 1, and the object may be a magnet or an iron block and the like. The number of the fixing means 10 on the base 4 may be one, or more than two. The spring 14 may be located in the second cavity A2, and such a structure may obtain the same object of this present invention.

While the specific embodiments have been illustrated and described, numerous modifications come to mind without significantly departing from the spirit of the invention, and the scope of protection is only limited by the scope of the accompanying Claims.

What is claimed is:

1. A laser alignment device, comprising:
a body with a an attachment member on one surface thereof;
a base with a surface that cooperates with the attachment member to removeably retain the body and a suction cup having a push rod and piston assembly for withdrawing air from the suction cup to mount the base onto a desired surface; and,
a laser emitter located in the body which emits a fan-shaped laser beam.

2. The laser alignment device of claim 1, wherein the attachment member is a magnet.

3. The laser alignment device of claim 1, wherein the base comprises a second suction cup having a push rod and piston assembly for withdrawing air from the second suction cup to mount the base onto the desired surface.

4. The laser alignment device of claim 1, wherein the push rod and piston assembly includes a biasing member.

5. The laser alignment member of claim 4, wherein the biasing member is a spring.

6. The laser alignment device of claim 1, wherein the push rod and piston assembly is located within a cylinder.

7. The laser alignment device of claim 6, wherein the cylinder is connected to the suction cup.

8. The laser alignment device of claim 7, wherein the cylinder and suction cup are in fluid communication.

9. The laser alignment device of claim 7, wherein a through hole connects the cylinder and the suction cup.

10. The laser alignment device of claim 6 further comprising a first and second cavity, the first cavity formed between the desired surface and the suction cup and the second cavity formed between the piston and the suction cup, the first cavity being in fluid communication with the second cavity.

11. The laser alignment device of claim 10 further comprising a third cavity formed between the piston and a cap positioned on one end of the cylinder opposite from the suction cup.

12. The laser alignment device of claim 11, wherein the third cavity is in fluid communication with an ambient atmosphere.

13. The laser alignment device of claim 1 further comprising means for automatically withdrawing air from the suction cup.

14. The laser alignment device of claim 1, wherein the suction cup and the desired surface form a first cavity having an air pressure associated therewith, and the device further comprises means for adjusting the air pressure associated with the first cavity.

15. A laser generating device comprising:
a housing having a laser generator therein;
a base removeably connected to the housing, the base having a suction cup assembly for fixing the base to a desired surface, the suction cup assembly comprising:
a suction cup connected to a first end of a cylinder;
a piston connected to a rod, the rod and piston moveable within the cylinder;
a first cavity defined by the suction cup and the desired surface, a second cavity defined by the piston and the cylinder, the second cavity being in fluid communication with the first cavity, and a third cavity separated from the second cavity and also defined by the piston and the cylinder, the third cavity being in fluid communication with an ambient atmosphere;
a spring which applies a force to move the piston within the cylinder and withdraw air from the first cavity.

16. The laser generating device of claim 15 further comprising a wall with an opening attached to a second end of the cylinder.

17. The laser generating device of claim 16 wherein the rod is connected to a cap having an open interior volume.

18. The laser generating device of claim 17, wherein the spring is between the wall of the cylinder and the cap.

19. The laser generating device of claim 15, wherein the suction cup creates a seal with the desired surface which will allow for influx of air into the first cavity increasing pressure in the first cavity and forcing the piston to move within the cylinder towards the third cavity, thereby increasing a volume of space defined by the first and second cavities and reducing the pressure in the first cavity.

20. The laser generating device of claim 15 further comprising a second suction cup assembly for fixing the base to a desired surface, the second suction cup assembly comprising:
a suction cup connected to a first end of a cylinder;
a piston connected to a rod, the rod and piston moveable within the cylinder;
a first cavity defined by the suction cup and the desired surface, a second cavity defined by the piston and the cylinder, the second cavity being in fluid communication with the first cavity, and a third cavity separated from the second cavity and also defined by the piston and the cylinder, the third cavity being in fluid communication with an ambient atmosphere;
a spring which applies a force to move the piston within the cylinder and withdraw air from the first cavity.
